(19) United States
(12) Patent Application Publication
(10) Pub. No.: US 2005/0198646 A1
(43) Pub. Date: Sep. 8, 2005

(54) Method, data processing device, computer program product and arrangement for processing electronic data

(75) Inventor: Jukka Kortela, Helsinki (FI)

Correspondence Address: PILLSBURY WINTHROP SHAW PITTMAN LLP, P.O. BOX 10500, MCLEAN, VA, 22102, US

(73) Assignee: Helmi Technologies OY

(21) Appl. No.: 11/069,630

(22) Filed: Feb. 28, 2005

(30) Foreign Application Priority Data
Mar. 3, 2004 (FI) 20040347

(51) Int. Cl. G06F 9/46

(52) U.S. Cl. 719/310; 717/170

(57) ABSTRACT

A method, a data processing device, a computer program product and an arrangement for processing electronic data are provided. In the method, electronic data is read by a browser of the data processing device and the browser is identified. Then, classes implementing a virtual browser and appropriate for the identified browser are downloaded into the data processing device. Finally, a virtual object model is formed from the electronic data by the virtual browser, the electronic data is processed by utilizing the virtual browser and the virtual object model, program code contained in the electronic data being written in a manner required by the virtual browser, and both the program code and the browser's presentation of the electronic data being independent of the browser and the data processing device used.

### FIELD

The invention relates to a method of processing electronic data by a data processing device, a data processing device for processing electronic data, a computer program product which encodes a computer process for processing electronic data by a data processing device, and to an arrangement for processing electronic data.

### BACKGROUND

When Netscape® 4 and Microsoft® Internet Explorer 4™ were released in 1997, they were among the first browsers to support dynamic document modification. They were implemented differently, so a code designed for one did not work for the other. For example, a layer element of Netscape® 4 is referred to as a call “document.layers” while a corresponding div element in Internet Explorer 4™ is referred to as “document.all”.

Within six years, three browser versions have been released for Internet Explorer™ and five for Netscape®. Other browsers include, for example, Konquor™, Mozilla™ and Safari™ of Mac OS X™ operating system. In addition, browsers in different operating systems may differ from one another. Mobile terminals and PDA (Personal Digital Assistant) devices also have their specific versions of browsers.

Since a Web developer is compelled to take the different browsers into account, the code becomes complex. Testing on all browsers is difficult, so more sophisticated functions increase the danger of non-functioning. In practice, an “object model” formed by different browsers is different and the methods of objects operate in a different way, which is why each browser has to be separately taken into account when writing the program code.

### BRIEF DESCRIPTION

An object of the invention is to provide an improved method of processing electronic data by a data processing device, an improved data processing device for processing electronic data, an improved computer program product which encodes a computer process for processing electronic data by a data processing device, and an improved arrangement for processing electronic data.

As an aspect of the invention there is provided a method of processing electronic data by a data processing device, comprising: reading electronic data by a browser of the data processing device; identifying the browser; downloading, into the data processing device, classes implementing a virtual browser and appropriate for the identified browser; forming a virtual object model from the electronic data by the virtual browser; and processing the electronic data by utilizing the virtual browser and the virtual object model, program code contained in the electronic data being written in a manner required by the virtual browser, and both the program code and the browser's presentation of the electronic data being independent of the browser and the data processing device used.

As an aspect of the invention there is provided a data processing device for processing electronic data, comprising: a browser for processing electronic data; and an identification module configured to identify the browser or to receive browser identification information. The data processing device further comprises: a downloading module configured to download classes implementing a virtual browser and appropriate for the identified browser; the virtual browser being configured to form a virtual object model from the electronic data and process the electronic data by utilizing the virtual object model, program code contained in the electronic data being written in a manner required by the virtual browser, and both the program code and the browser's presentation of the electronic data being independent of the browser and the data processing device used.

As an aspect of the invention there is provided a computer program product which encodes a computer process for processing electronic data by a data processing device, the computer program product comprising: reading electronic data by a browser of the data processing device; identifying the browser; downloading, into the data processing device, classes implementing a virtual browser and appropriate for the identified browser; forming a virtual object model from the electronic data by the virtual browser; and processing the electronic data by utilizing the virtual browser and the virtual object model, program code contained in the electronic data being written in a manner required by the virtual browser, and both the program code and the browser's presentation of the electronic data being independent of the browser and the data processing device used.

As an aspect of the invention there is provided an arrangement for processing electronic data, comprising: browsing means for processing electronic data, and identification means for identifying the browsing means. The arrangement further comprises downloading means for downloading virtual browsing means appropriate for the identified browsing means, the virtual browsing means being configured to form a virtual object model from the electronic data, and to process the electronic data by utilizing the virtual object model, program code contained in the electronic data being written in a manner required by the virtual browsing means, and both the program code and the presentation of the browsing means of the electronic data being independent of the browsing means used.

Several advantages are achieved by the invention. A programmer does not have to take into account different browsers and the versions thereof since the program code written by the particular programmer needs to operate in a manner required by a virtual browser only. The described virtual browser mechanism is then responsible for the program code written by the particular programmer operating in the same way on different browsers. Using a virtual browser mechanism, a browser may provide more complex, more affluent and more sophisticated user interface elements.

### LIST OF DRAWINGS

The invention is now described in closer detail in connection with preferred embodiments and with reference to the accompanying drawings, in which

FIGS. 1 and 2 show browsers in different environments;

FIG. 3 shows a structure of a data processing device;

FIG. 4 is a flow chart illustrating a method of processing electronic data by a data processing device;

FIGS. 5 and 6 illustrate advantages of using a virtual browser;

FIG. 7 illustrates identifying a browser;

FIG. 8 is a signal sequence diagram illustrating processing of electronic data by a browser;

FIG. 9 is a signal sequence diagram illustrating creation of a new element in a browser; and

FIG. 10 illustrates error handling in a virtual browser.

### DESCRIPTION OF EMBODIMENTS

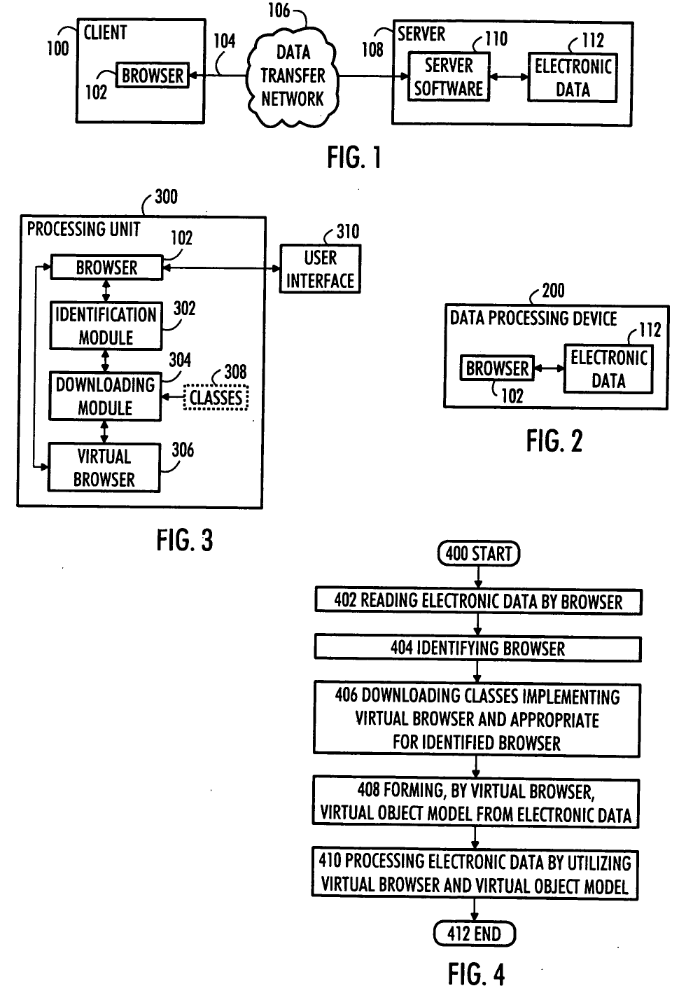

Conventionally, a browser refers to software for repeating WWW (World Wide Web) pages, e.g. the software disclosed in the background section. FIG. 1 describes operation of a browser in a client/server architecture. A browser 102 resides in a client device 100. The client device 100 may be e.g. a computer, a portable computer, a PDA (Personal Digital Assistant) device, a subscriber terminal in a radio system, such as a mobile telephone, or another prior art data processing device. From the client device 100 a data transfer connection 104 is provided via a data transfer network 106 to a server 108. The data transfer network 106 may be e.g. a wired data transfer network, such as the Internet or a private network, or a wireless data transfer network, such as GSM (Global System for Mobile Communications) or UMTS (Universal Mobile Telecommunications System). Today, wired data transfer networks commonly employ TCP/IP (Transmission Control Protocol/Internet Protocol) but other appropriate data transfer protocols may also be used. Wireless data transfer networks are not restricted exclusively to the mobile communication systems given as examples, either, but other appropriate wireless data transfer networks may also be used. An example of other wireless data transfer networks is WLAN (Wireless Local Area Network), defined e.g. in 802.11 series standards by IEEE (The Institute of Electrical and Electronics Engineers, Inc.). Another example of wireless data transfer networks is a Bluetooth® network implemented by short-range radio transceivers. The server 108 is provided with server software 110 for processing electronic data 112. The browser 102 may ask the server software 110 for desired electronic data to be processed.

The browser 102 may, however, also be used in environments different from that provided in the client/server architecture described in FIG. 1. FIG. 2 describes an embodiment wherein the browser 102 and the electronic data 112 to be processed both reside in the same data processing device 200. Hence, such a data processing device 200 does not necessarily have to be provided with the possibility to establish a data transfer connection with other devices. The browser 102 is thus not used for browsing electronic data that has been retrieved elsewhere, as in FIG. 1, but the browser 102 establishes a user interface to the local electronic data 112. In addition to the browser 102 being capable of repeating documents, it is also otherwise capable of constituting a part of the user interface of the data processing device, i.e. it may also be used for presenting data of another type than mere documents. A document may also constitute an entire application source code. A document may also be generated at the server 108 dynamically. A browser may also be perceived as a network page development tool of the type of Macromedia™ Dreamweaver™. In such a case, the browser 102 and virtual browser technology to be described below can be used as early as during program development. In such a case, an element in Dreamweaver™ called a rendering engine may be replaced by a rendering engine of a virtual browser, for instance.

The data processing device used for processing electronic data may thus be of the type of the client device 100 shown in FIG. 1 and/or of the type of the independent data processing device 200 described in FIG. 2. In a simplified manner, FIG. 3 describes a structure of a data processing device used for processing electronic data. The data processing device includes a processing unit 300 and a user interface 310. The user interface 310 is used for implementing user interaction with the data processing device and its software. The user interface 310 may include e.g. the following elements: keyboard, display, pointing device, loudspeaker, microphone or other prior art user interface elements. The processing unit 300 may be e.g. a microprocessor including its memory, e.g. a microprocessor used in personal computers, manufactured by Intel®. The processing unit 300 may be used for running an operating system (e.g. Windows® or Symbian®) and application software. An example of such application software is the browser 102 used for processing electronic data.

The processing unit 300 may further include an identification module 302 configured to identify the browser 102 or to receive identification information of the browser 102. Identification of the browser 102 mainly refers to identifying the type of the browser, i.e. what kind of processing of electronic data the particular browser supports. In practice, identification may be based on the name and version number of a browser. The identification module 302 may also receive the identification information of the browser 102 from an external element, i.e. in the environment according to FIG. 1, from server software 110. For the identification of the browser 102, a program to identify browser software may be downloaded into the data processing device.

The processing unit 300 also includes a downloading module 304 configured to download classes 308 implementing a virtual browser and appropriate for the identified browser 102. In the environment according to FIG. 1, the classes 308 may be downloaded into the browser 102 residing in the client device 100 from the server 108. In the environment according to FIG. 2, the classes 308 may reside in the same data processing device 200 as the browser 102.

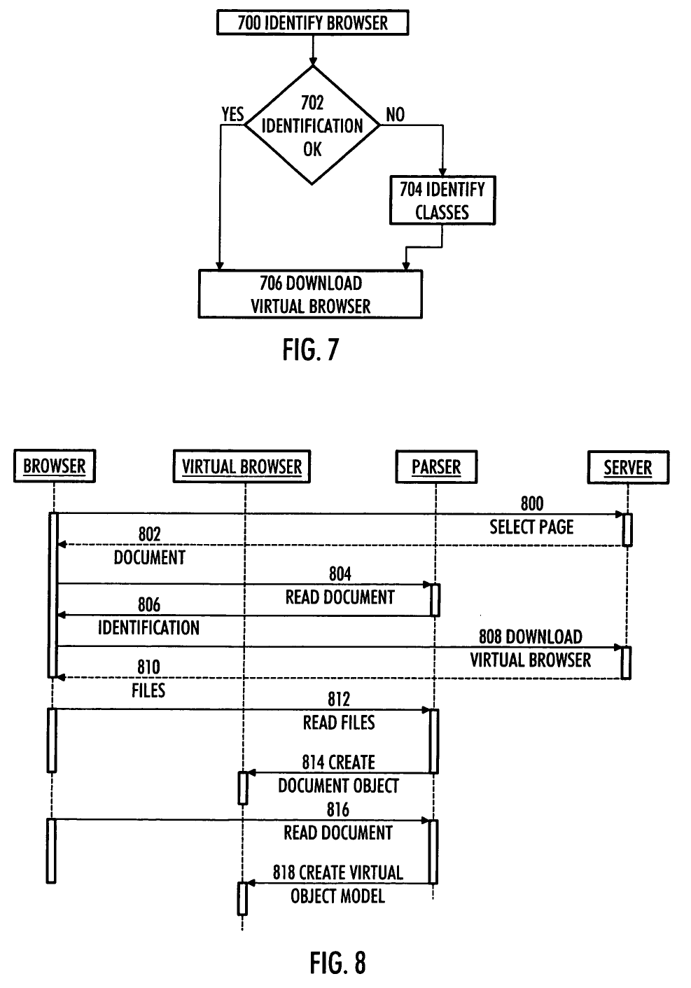

FIG. 7 describes an embodiment of identifying a browser. First, in 700, a browser is identified, whereafter, in 702, it is checked whether or not the identification was successful. If the identification was successful, a virtual browser may be downloaded into a data processing device in 706. If the identification was unsuccessful, classes implementing the virtual browser and needed by the particular browser may, in 704, be identified one by one, whereafter, in 706, the virtual browser may be downloaded into the data processing device. Prior to downloading the classes implementing the virtual browser, the classes implementing the virtual browser needed for a previously known browser may be placed in one file.

Due to the operation of the downloading module 304, the processing unit 300 is provided with a virtual browser 306, which is configured to form a virtual object model from electronic data and to process electronic data by utilizing the virtual object model. In such a case, program code contained in the electronic data is written as required by the virtual browser 306, and both the program code and the presentation of the browser 102 of the electronic data are independent of the browser 102 and data processing device used. Electronic data may thus include program code, e.g. program code provided in a markup language or in a script language. Examples of markup languages include HTML (Hypertext Markup Language), XHTML (Extensible HTML), DHTML (Dynamic HTML), XML (Extensible Markup Language), and examples of script languages include JavaScript developed by Netscape® and JScript developed by Microsoft®. The markup/script language may be any known language supported by a browser, or a language defined by a standard. For instance, standard ECMA-262 given by ECMA (Ecma International—European association for standardizing information and communication systems) defines an ECMASript language.

Electronic data is thus processed parallelly, as it were, both by the browser 102 and the virtual browser 306. However, the virtual browser 306 is not directly connected to the user interface 310 but the browser 102 carries out audiovisual presentation of electronic data, e.g. by using a display and a loud-speaker contained in the user interface 310.

However, since the program code contained in the electronic data is written in the manner required by the virtual browser 306 in particular, and not as required by the browser 102, the virtual browser 306 creates a virtual object model via which electronic data is mainly processed. In an embodiment, the virtual browser 306 is configured to refer to elements contained in the electronic data via a virtual object model. In an embodiment, the virtual browser 306 is configured to modify electronic data via a virtual object model. In an embodiment, the virtual browser 306 is configured to modify a virtual object model in accordance with the modification of electronic data and to write the modified virtual object model into the actual object model of the browser 102. In an embodiment, the virtual browser 306 is configured to implement interactive functions via a virtual object model (however, as was explained above, also via the browser 102). In an embodiment, the virtual browser 306 is configured to execute event handling via a virtual object model. In an embodiment, the virtual browser 306 is further configured to execute error handling via a virtual object model.

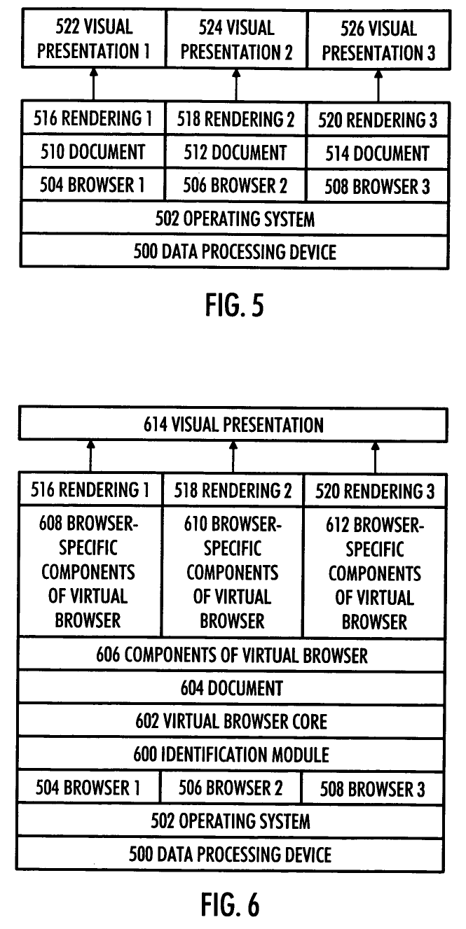

As was stated above, when a virtual browser 306 is used, the program code contained in electronic data is written in a manner required by the virtual browser 306, and both the program code and the browser's 102 presentation of the electronic data are independent of the browser 102 and the data processing device used. FIGS. 5 and 6 serve to clarify what is meant by this. FIG. 5 describes how, according to prior art, electronic data is processed. In our example, electronic data is a hypertext document written in a markup and/or script language. According to prior art, a document has to be written such that a different version 510, 512, 514 of the document is provided for each different browser 504, 506, 508. According to another prior art solution, only one version of a document is provided which contains selection logic in order to enable different program code required by each different browser to be included in one version. In a third prior art solution, the program code contained in a document is simple (and poor) enough to run on all browsers 504, 506, 508 in a sufficiently same manner without identification logic. A data processing device 500 includes an operating system 502 and one of the three browsers 504/506/508, which is then used for processing a document 510/512/514 intended for the particular browser. Furthermore, the browser 504/506/508 includes a “rendering engine” 516/518/520 corresponding with the particular browser to present the document. As can be seen in FIG. 5, the visual presentation of each document 510/512/514 is, regrettably, different. In principle, the visual presentation 522/524/526 might be similar for different browsers but this would be laborious (requiring e.g. testing) for the programmer. Due to costs in particular, the prior art solutions are thus incapable of enabling the visual presentation to be the same for different browsers.

In the manner described in FIG. 6, a virtual browser core 602, virtual browser components 606 and browser-specific components (classes) 608/610/612 corresponding with the browser 504/506/508 contained in the data processing device are downloaded into a data processing device 500 by means of an identification module 600. As can be seen in FIG. 6, only one document 604 is necessary and it contains no selection logic for different browsers 504/506/508. Furthermore, and most importantly, one document 604, presented “via” the virtual browser, enables the visual presentation 614 of the document always to be similar, regardless of the browser 504/506/508 and its rendering engine 516/518/520 used for the presentation.

How, then, is the program code contained in the electronic data written in the manner required by the virtual browser 306? In practice, this may be carried out in any standard or non-standard manner. In an embodiment, the program code follows a DOM (Document Object Model) standard and/or a JavaScript syntax. The DOM standard is defined by W3C (World Wide Web Consortium). DOM is a platform- and language-neutral interface which enables programs and scripts to dynamically utilize and update the contents, structure and style of documents. DOM defines an API (Application Programming Interface), which enables a programmer to produce documents. Further information on DOM is available on the W3C netpages which, at the time of writing the present application, can be found at www.w3.org. Different versions of the DOM exist; a virtual browser may require e.g. DOM Level 2, DOM Level 3 or a forthcoming version of the DOM to be used. Modules implementing a virtual browser and appropriate for the identified browser which are to be downloaded into a data processing device may comprise a Core module, XML module, HTML module, Views module, Style Sheets module, CSS module, CSS2 module, Events module, User Interface Events module, Mouse Events module, Mutation Events module, HTML Events module, Range module and/or a Traversal module.

In an embodiment, the virtual browser 306 is configured to process calls contained in electronic data and to direct them to real methods of the browser 102. As far as the programmer is concerned, the virtual browser 306 “encapsulates” the browser 102. In an embodiment, the virtual browser 306 is configured to process data returned by a method of the browser 102 and outgoing data to be in accordance with the DOM standard.

Next, referring to FIG. 4, a method of processing electronic data by a data processing device will be explained. The method starts in 400. Then, in 402, electronic data is read by a browser of a data processing device, and in 404, the browser is identified. Next, in 406, classes implementing a virtual browser and appropriate for the identified browser are downloaded into the data processing device, and in 408, a virtual object model is formed from the electronic data by the virtual browser. Finally, in 410, the electronic data is processed by utilizing the virtual browser and the virtual object model, the program code contained in the electronic data being written in a manner required by the virtual browser, and both the program code and the browser's presentation of the electronic data being independent of the browser and the data processing device used. Procedures 408 and 410 may be repeated many times, depending e.g. on references to elements contained in electronic data via a virtual object model, modification of electronic data via a virtual object model, implementation of interactive functions via a virtual object model, execution of event handling via a virtual object model and execution of error handling via a virtual object model. The method ends in 412. The described method can be modified by embodiments described above in connection with a data processing device and in accordance with the accompanying dependent method claims. A data processing device of the type described above can be applied to implementing the method.

The method may also be implemented as a computer program product which encodes a computer process for processing electronic data by a data processing device, the computer process comprising the procedures of the above-disclosed method. The computer program product may be stored on to a computer program distribution device. The computer program distribution device is readable by the data processing device. The distribution device may be any known device for distributing a computer program from a manufacturer/vendor to an end user. The distribution device may be e.g. media, program storage media or storage media readable by a data processing device, memory or software distribution package readable by a data processing device, and a signal, telecommunication signal or a compressed software package understood by a data processing device.

Finally, different examples of a more detailed implementation of the above-described embodiments will be described.

The above-described embodiment employing DOM is compatible with the most recent standards DOM Level 2 Core, DOM Level 2 HTML, DOM Level 2 Style and DOM level 2 Events. A developer only needs to write one code according to DOM Level 2 standard and it will work on all browsers in the same manner. This includes a rendering engine, i.e. the way in which elements are drawn into a browser, and handling of events and errors. A virtual browser 306 enables a developer to design almost operating-system-level graphic components. And later, as the performance capacity of hardware increases, operating-system-level graphic elements/functionalities as well.

On top of each browser 102, a virtual layer may be downloaded which includes an object model in accordance with the DOM Level 2 standard, herein called a virtual object model. The virtual browser 306 may employ an existing JavaScript, CSS (Cascading Style Sheet), event and HTML model for creating the layer. This means that the entire browser is 100% rebuilt.

Virtual browser support may be downloaded utilizing JavaScript. The identification module 302 first checks which browser is in question and downloads classes necessary for the particular browser exclusively. When the browser is a new browser, the virtual browser 306 enables support to be built automatically.

The virtual browser 306 may operate in the following manner. When an HTML document is downloaded, the virtual browser 306 builds a virtual object model of its own from the document. When HTML code includes standard DHTML calls, the virtual browser 306 handles the calls and directs them to the methods of the browser 102. The virtual browser 306 utilizes a real object model and handles the calls such that they operate according to the standard. Similarly, when the browser 102 is e.g. asked for information on an element, such as colours, or events are listened, the virtual browser 306 returns the call according to the standard.

Next, a brief code example:
div1=document2.createElement(“DIV”);
div1.style.setProperty(“background-color”,“#FF0000”);
div1.style.setProperty(“width”,“100px”);
div1.style.setProperty(“height”,“100px”);
document2.body.appendChild(div1);

In the first line of the example, an element is created, which is a DIV tag in HTML. For example, in connection with Microsoft® Internet Explorer 6™, the virtual browser 306 calls a createElement call of the browser 102, but returns a virtual object. In the next lines, the background colour, width and height are set. The virtual browser 306 changes the calls to conform with Microsoft® Internet Explorer™, e.g. the second line is changed into a form: div1.style.backgroundcolor=“#FF0000”. The last line adds the element as the last element of the body tag of the document.

Another brief code example:
function eventListener1(e) {
}
div1.addEventListener(“click”, eventListener1,false);

The virtual browser 306 operates in a manner to be described in the following. For example, in connection with Netscape® 4, the virtual browser 306 calls a “captureEvents” method of an element of the browser 102 such that a listener operates with the element. Furthermore, it sets a click listener of the element to refer to the listener of the virtual browser 306. Microsoft® Internet Explorer 4™ operates in a similar manner, except that no captureEvents method needs to be called.

When a user clicks the element, a listener to the virtual browser 306 handles the Event object such that it is in accordance with the DOM Level 2 standard. The virtual browser 306 calls an eventListener1 function with an Event virtual object as its parameter. Next, a parser executes the code contained in the eventListener1 function.

Next, referring to FIG. 8, a way of processing electronic data by a virtual browser 306 will be described. When a user uses a browser and points at a desired document, the browser sends 800 a server a request indicating that it desires the particular document. The server then returns 802 the desired document to the user.

A parser of the browser reads 804 the document from top to bottom, starting at a head tag, and next, the browser moves on to a body tag of the document. Tags are for indicating where the contents of the elements of a document start and end. An element may be e.g. a section which contains text. A first tag in the head tag is a script tag, which contains the JavaScript code necessary for identifying 806 the browser.

The browser is identified e.g. in the following manner. The code first tests whether or not the browser is a known one. If not, the code tests which classes are the most appropriate for the browser. Next, the code asks 808 for files which contain classes necessary for creating a virtual object model of the virtual browser. The server returns 810 the files to the browser.

The parser of the browser reads 812 the JavaScript files and executes the calls contained therein. After the document has been read, the browser creates 814 a document2 virtual object to refer to the virtual object model of the virtual browser. The document2 virtual object enables elements according to the DOM Level 2 standard to be created and them to be processed by means of the virtual browser. The browser then reads 816 the rest of the document. After the body tag has been read, the virtual browser creates 818 a virtual object model of its own from the tags of the document in order to enable the tags to be referred to by software. The browser draws body tag expressions in a markup language.

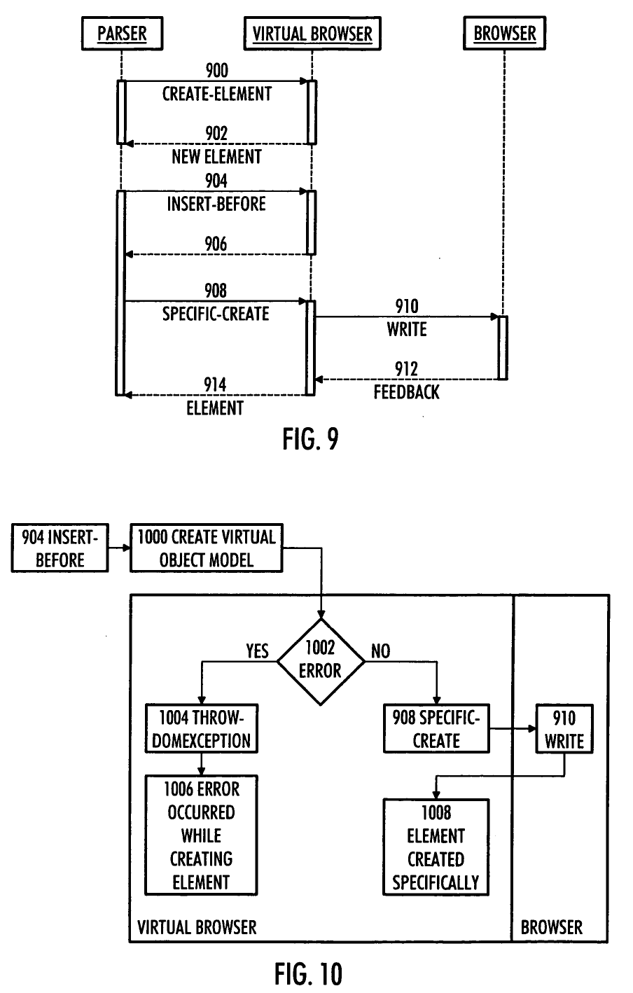

FIG. 9 describes co-operation of a parser, a virtual browser and a browser. When the parser calls 900 a createElement method of the virtual browser, the virtual browser creates an Element object of the type of the given parameter and returns 902 it (e.g. according to DOM Level 2-Core specification).

An element may be placed in a document e.g. by employing an insertBefore method. When the parser calls 904 the insertBefore method, the virtual browser places the element into a virtual object model and returns 906 a control to the parser. The parser calls 908 a specificCreate method, by which an element is created such that it can be visually seen at the browser. Next, the virtual browser calls the method of the browser by which the element is made visible on a screen. The method may be e.g. a write method 910, which rewrites the contents of the element according to the virtual object model and gives 912 feed-back on the creation, or it may be an insertBefore method if the browser supports this method. If the call of the method is erroneous, the virtual browser creates a DOMException object and throws it to an error handler (cf. FIG. 10); otherwise the created element is returned 914 to the parser. Usually browsers enable the contents of an element to be changed by an innerHTML parameter or a write method, but an insertBefore command which would enable an element to be placed before another is not possible for all browsers. Next, a brief pseudocode of creation of an element will be presented.

The first method returns the Element object, its tagName parameter being of String type, and the method is capable of throwing a DOMException object.

```
procedure createElement(tagName);
{
  elm = new HTMLElement( );
  return elm;
}
```

The second method returns a Node object, its newChild parameter being a Node object, refChild being a Node object, childNodes being childNodes of Node, and the method is capable of throwing a DOMException object.

```
procedure insertBefore(newChild, refChild);
{
  for i := 0 to length−1
    if refChild == childNodes[i]
    {
      for j := length−1 to 0
        childNodes[j+1] = childNodes[j];
      childNodes[i] = newChild;
    }
  specificCreate( );
}
procedure specificCreate( );
{
  write contents of element;
}
```

An example of error handling is shown in FIG. 10. When an InsertBefore method 904 according to FIG. 9 is executed, a virtual object model is first created 1000. In block 1002, it is tested whether or not this was successful; if no errors occurred, specificCreate and write methods are then executed 908, 910, and finally, the process moves into a state 1008 according to which the creation of the element specifically was successful. If errors did occur, the process moves from block 1002 to 1004, wherein a DOMException is created and it is thrown to an error handler, and finally the process moves into a state 1006 according to which an error occurred while creating the element. Errors may, for example, be as follows:
HIERARCHY_REQUEST_ERR: element does not allow elements of the newChild type, or element is already higher in the virtual object model;
WRONG_DOCUMENT_ERR: newChild has been created in a document different from the element in question;
NO_MODIFICATION ALLOWED ERR: element or mother element into which it is being placed is write-protected; and
NOT FOUND ERR: refChild is no child of this element.

Error message objects are returned, produced by the virtual browser, in order for them to be similar regardless of the browser used.

Although the invention has been described above with reference to the example according to the accompanying drawings, it is clear that the invention is not restricted thereto but can be modified in many ways within the scope of the attached claims.

1. A method of processing electronic data by a data processing device, comprising:
reading electronic data by a browser of the data processing device;
identifying the browser;
downloading, into the data processing device, classes implementing a virtual browser and appropriate for the identified browser;
forming a virtual object model from the electronic data by the virtual browser; and
processing the electronic data by utilizing the virtual browser and the virtual object model, program code contained in the electronic data being written in a manner required by the virtual browser, and both the program code and the browser's presentation of the electronic data being independent of the browser and the data processing device used.

2. A method as claimed in claim 1, further comprising:
referring to elements contained in the electronic data via the virtual object model.

3. A method as claimed in claim 1, further comprising:
modifying the electronic data via the virtual object model.

4. A method as claimed in claim 3, further comprising:
modifying the virtual object model in accordance with the modification of the electronic data and writing the modified virtual object model into an actual object model of the browser.

5. A method as claimed in claim 1, further comprising:
implementing interactive functions via the virtual object model.

6. A method as claimed in claim 1, further comprising:
executing event handling via the virtual object model.

7. A method as claimed in claim 1, further comprising:
executing error handling via the virtual object model.

8. A method as claimed in claim 1, wherein the program code follows a DOM standard and/or a JavaScript syntax.

9. A method as claimed in claim 1, further comprising:
the virtual browser processing calls contained in the electronic data and directing them to real methods of the browser.

10. A method as claimed in claim 9, further comprising:
processing data returned by a method of the browser and outgoing data to be in accordance with the DOM standard.

11. A data processing device for processing electronic data, comprising:
a browser for processing electronic data;
an identification module configured to identify the browser or to receive browser identification information;
a downloading module configured to download classes implementing a virtual browser and appropriate for the identified browser;
the virtual browser being configured to form a virtual object model from the electronic data and process the electronic data by utilizing the virtual object model, program code contained in the electronic data being written in a manner required by the virtual browser, and both the program code and the browser's presentation of the electronic data being independent of the browser and the data processing device used.

12. A data processing device as claimed in claim 11, wherein the virtual browser is further configured to refer to elements contained in the electronic data via the virtual object model.

13. A data processing device as claimed in claim 11 wherein the virtual browser is further configured to modify the electronic data via the virtual object model.

14. A data processing device as claimed in claim 13, wherein the virtual browser is further configured to modify the virtual object model in accordance with the modification of the electronic data and to write the modified object model into an actual object model of the browser.

15. A data processing device as claimed in claim 11, wherein the virtual browser is further configured to implement interactive functions via the virtual object model.

16. A data processing device as claimed in claim 11, wherein the virtual browser is further configured to execute event handling via the virtual object model.

17. A data processing device as claimed in claim 11, wherein the virtual browser is further configured to execute error handling via the virtual object model.

18. A data processing device as claimed in claim 11, wherein the program code follows a DOM standard and/or a JavaScript syntax.

19. A data processing device as claimed in claim 11, wherein the virtual browser is further configured to process calls contained in the electronic data and to direct them to real methods of the browser.

20. A data processing device as claimed in claim 19, wherein the virtual browser is further configured to process data returned by the browser and outgoing data to be in accordance with the DOM standard.

21. A computer program product encoding a computer process for processing electronic data by a data processing device, the computer process comprising:
reading electronic data by a browser of the data processing device;
identifying the browser;
downloading, into the data processing device, classes implementing a virtual browser and appropriate for the identified browser;
forming a virtual object model from the electronic data by the virtual browser; and
processing the electronic data by utilizing the virtual browser and the virtual object model, program code contained in the electronic data being written in a manner required by the virtual browser, and both the program code and the browser's presentation of the electronic data being independent of the browser and the data processing device used.

22. An arrangement for processing electronic data, comprising
browsing means for processing electronic data,
identification means for identifying the browsing means,
downloading means for downloading virtual browsing means appropriate for the identified browsing means, the virtual browsing means being configured to form a virtual object model from the electronic data, and to process the electronic data by utilizing the virtual object model, program code contained in the electronic data being written in a manner required by the virtual browsing means, and both the program code and the presentation of the browsing means of the electronic data being independent of the browsing means used.
